(19) United States
(12) Patent Application Publication
(10) Pub. No.: US 2026/0303864 A1
(43) Pub. Date: Oct. 1, 2026

(54) MULTIPLE ALTERNATIVE REPRESENTATION OF VOLUMETRIC DATA

(71) Applicant: Samsung Electronics Co., Ltd., Suwon-si (KR)

(72) Inventor: Youngkwon Lim, McKinney, TX (US)

(21) Appl. No.: 19/562,655

(22) Filed: Mar. 10, 2026

Related U.S. Application Data
(60) Provisional application No. 63/778,230, filed on Mar. 26, 2025.

(51) Int. Cl. H04N 19/597

(52) U.S. Cl. CPC H04N 19/597

(57) ABSTRACT

An apparatus includes a communication interface configured to receive a compressed bitstream comprising volumetric data. The apparatus also includes a processor operably coupled to the communication interface. The processor is configured to determine, from two or more volumetric data types, a type of volumetric data to be rendered. The processor is also configured to retrieve the volumetric data corresponding to the determined type of volumetric data from the compressed bitstream. The processor is also configured to reconstruct the volumetric data for rendering.

### CROSS-REFERENCE TO RELATED APPLICATION AND PRIORITY CLAIM

This application claims priority under 35 U.S.C. § 119(e) to U.S. Provisional Patent Application No. 63/778,230 filed on Mar. 26, 2025, which is hereby incorporated by reference in its entirety.

### TECHNICAL FIELD

This disclosure relates generally to multimedia devices and processes. More specifically, this disclosure relates to multiple alternative representations of volumetric data.

### BACKGROUND

Three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

### SUMMARY

This disclosure provides for multiple alternative representations of volumetric data.

In one embodiment, an apparatus includes a communication interface configured to receive a compressed bitstream comprising volumetric data. The apparatus also includes a processor operably coupled to the communication interface. The processor is configured to determine, from two or more volumetric data types, a type of volumetric data to be rendered. The processor is also configured to retrieve the volumetric data corresponding to the determined type of volumetric data from the compressed bitstream. The processor is also configured to reconstruct the volumetric data for rendering.

In another embodiment, a method includes receiving a compressed bitstream comprising volumetric data. The method also includes determining, from two or more volumetric data types, a type of volumetric data to be rendered. The method also includes retrieving the volumetric data corresponding to the determined type of volumetric data from the compressed bitstream. The method also includes reconstructing the volumetric data for rendering.

In yet another embodiment, an apparatus includes a communication interface and a processor operably coupled to the communication interface. The processor is configured to determine two or more volumetric data types to be provided for rendering. The processor is also configured to create a compressed bitstream comprising at least one of the two or more volumetric data types, The processor is also configured to transmit, via the communication interface, the compressed bitstream to another apparatus.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with this disclosure;

FIGS. 2 and 3 illustrate example electronic devices in accordance with this disclosure;

FIG. 4 illustrates an example volumetric media content flow process in accordance with this disclosure;

FIG. 5 illustrates example alternative volumetric data representations in accordance with this disclosure;

FIG. 6 illustrates an example encoding method in accordance with this disclosure; and

FIG. 7 illustrates an example decoding method in accordance with this disclosure.

### DETAILED DESCRIPTION

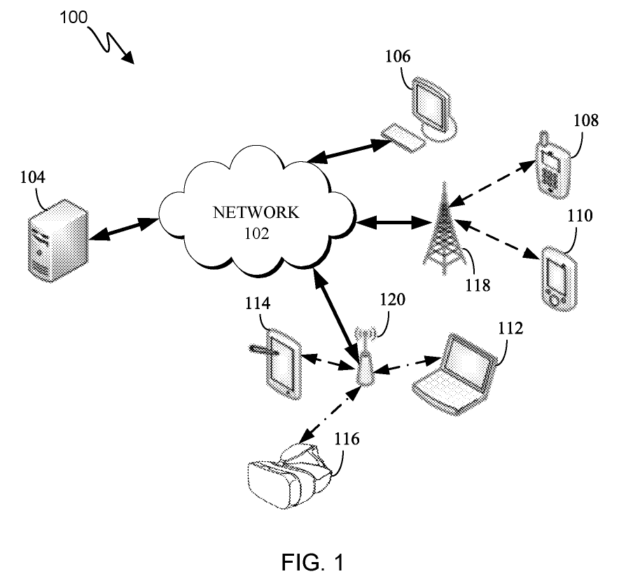

FIGS. 1 through 7, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

As noted above, three hundred sixty degree (360°) video and three dimensional (3D) volumetric video are emerging as new ways of experiencing immersive content due to the ready availability of powerful handheld devices such as smartphones. While 360° video enables an immersive “real life,” “being-there,” experience for consumers by capturing the 360° outside-in view of the world, 3D volumetric video can provide a complete six degrees of freedom (DoF) experience of being immersed and moving within the content. Users can interactively change their viewpoint and dynamically view any part of the captured scene or object they desire. Display and navigation sensors can track head movement of a user in real-time to determine the region of the 360° video or volumetric content that the user wants to view or interact with. Multimedia data that is 3D in nature, such as point clouds or 3D polygonal meshes, can be used in the immersive environment. This data can be stored in a video format and encoded and compressed for transmission as a bitstream to other devices.

A point cloud is a set of 3D points along with attributes such as color, normal directions, reflectivity, point-size, etc. that represent an object’s surface or volume. Point clouds are common in a variety of applications such as gaming, 3D maps, visualizations, medical applications, augmented reality, virtual reality, autonomous driving, multi-view replay, and six degrees of freedom (DoF) immersive media, to name a few. Point clouds, if uncompressed, generally require a large amount of bandwidth for transmission. Due to the large bitrate requirement, point clouds are often compressed prior to transmission. Compressing a 3D object such as a point cloud, often requires specialized hardware. To avoid specialized hardware to compress a 3D point cloud, a 3D point cloud can be transformed into traditional two-dimensional (2D) frames and that can be compressed and later reconstructed and viewable to a user.

Polygonal 3D meshes, especially triangular meshes, are another popular format for representing 3D objects. Meshes typically include a set of vertices, edges and faces that are used for representing the surface of 3D objects. Triangular meshes are simple polygonal meshes in which the faces are simple triangles covering the surface of the 3D object. Typically, there may be one or more attributes associated with the mesh. In one scenario, one or more attributes may be associated with each vertex in the mesh. For example, a texture attribute (RGB) may be associated with each vertex. In another scenario, each vertex may be associated with a pair of coordinates, (u, v). The (u, v) coordinates may point to a position in a texture map associated with the mesh. For example, the (u, v) coordinates may refer to row and column indices in the texture map, respectively. A mesh can be thought of as a point cloud with additional connectivity information.

The point cloud or meshes may be dynamic, i.e., they may vary with time. In these cases, the point cloud or mesh at a particular time instant may be referred to as a point cloud frame or a mesh frame, respectively. Since point clouds and meshes contain a large amount of data, they require compression for efficient storage and transmission. This is particularly true for dynamic point clouds and meshes, which may contain 60 frames or higher per second.

As part of an encoding process, a base mesh can be coded using an existing mesh codec, and a reconstructed base mesh can be constructed from the coded original base mesh. The reconstructed base mesh can then be subdivided into one or more subdivided meshes and a displacement field is created for each subdivided mesh.

FIG. 1 illustrates an example communication system 100 in accordance with this disclosure. The embodiment of the communication system 100 shown in FIG. 1 is for illustration only. Other embodiments of the communication system 100 can be used without departing from the scope of this disclosure.

As shown in FIG. 1, the communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a TV, an interactive display, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. As described in more detail below, the server 104 can transmit a compressed bitstream, representing a point cloud or mesh, to one or more display devices, such as a client device 106-116. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. The HMD 116 can display 360° scenes including one or more dynamic or static 3D point clouds. In certain embodiments, any of the client devices 106-116 can include an encoder, decoder, or both. For example, the mobile device 108 can record a 3D volumetric video and then encode the video enabling the video to be transmitted to one of the client devices 106-116. In another example, the laptop computer 112 can be used to generate a 3D point cloud or mesh, which is then encoded and transmitted to one of the client devices 106-116.

In this example, some client devices 108-116 communicate indirectly with the network 102. For example, the mobile device 108 and PDA 110 communicate via one or more base stations 118, such as cellular base stations or eNodeBs (eNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s). In certain embodiments, the server 104 or any client device 106-116 can be used to compress a point cloud or mesh, generate a bitstream that represents the point cloud or mesh, and transmit the bitstream to another client device such as any client device 106-116.

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

In certain embodiments, any of the client devices 106-116 or the server 104 can create a 3D point cloud or mesh, compress a 3D point cloud or mesh, transmit a 3D point cloud or mesh, receive a 3D point cloud or mesh, decode a 3D point cloud or mesh, render a 3D point cloud or mesh, or a combination thereof. For example, the server 104 can compress a 3D point cloud or mesh to generate a bitstream and then transmit the bitstream to one or more of the client devices 106-116. As another example, one of the client devices 106-116 can compress a 3D point cloud or mesh to generate a bitstream and then transmit the bitstream to another one of the client devices 106-116 or to the server 104. In accordance with this disclosure, the server 104 and/or the client devices 106-116 can process compressed bitstreams comprising volumetric data, determine, from two or more volumetric data types, a type of volumetric data to be rendered, and retrieve the volumetric data corresponding to the determined type of volumetric data from the compressed bitstream to reconstruct the volumetric data for rendering.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

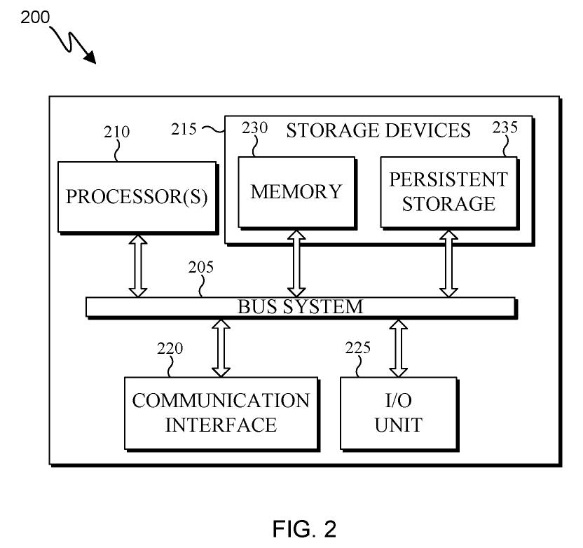

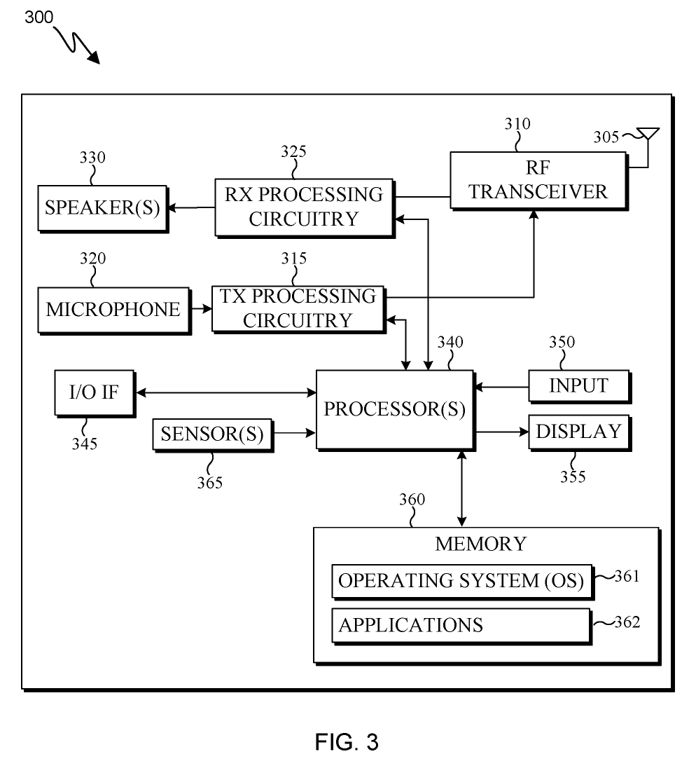

FIGS. 2 and 3 illustrate example electronic devices in accordance with this disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 can represent one or more local servers, one or more compression servers, or one or more encoding servers, such as an encoder. In certain embodiments, the encoder can perform decoding. As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

In certain embodiments, the processor 210 can encode a 3D point cloud or mesh stored within the storage devices 215. In certain embodiments, encoding a 3D point cloud also decodes the 3D point cloud or mesh to ensure that when the point cloud or mesh is reconstructed, the reconstructed 3D point cloud or mesh matches the 3D point cloud or mesh prior to the encoding. In certain embodiments, the processor 210 can process compressed bitstreams comprising volumetric data, determine, from two or more volumetric data types, a type of volumetric data to be rendered, and retrieve the volumetric data corresponding to the determined type of volumetric data from the compressed bitstream to reconstruct the volumetric data for rendering.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). For example, the instructions stored in the memory 230 can include instructions for decomposing a point cloud into patches, instructions for packing the patches on 2D frames, instructions for compressing the 2D frames, as well as instructions for encoding 2D frames in a certain order in order to generate a bitstream. The instructions stored in the memory 230 can also include instructions for rendering the point cloud on an omnidirectional 360° scene, as viewed through a VR headset, such as HMD 116 of FIG. 1. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of the processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, an SMS messaging client, a virtual assistant, and the like. In certain embodiments, the processor 340 is configured to receive and transmit media content.

In certain embodiments, the processor 340 can process compressed bitstreams comprising volumetric data, determine, from two or more volumetric data types, a type of volumetric data to be rendered, and retrieve the volumetric data corresponding to the determined type of volumetric data from the compressed bitstream to reconstruct the volumetric data for rendering.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user to interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within an HMD. The display 355 can be a singular display screen or multiple display screens capable of creating a stereoscopic display. In certain embodiments, the display 355 is a heads-up display (HUD). The display 355 can display 3D objects, such as a 3D point cloud or mesh.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, meshes, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 365 can further include control circuits for controlling any of the sensors included therein.

As discussed in greater detail below, one or more of these sensor(s) 365 may be used to control a user interface (UI), detect UI inputs, determine the orientation and facing the direction of the user for three-dimensional content display identification, and the like. Any of these sensor(s) 365 may be located within the electronic device 300, within a secondary device operably connected to the electronic device 300, within a headset configured to hold the electronic device 300, or in a singular device where the electronic device 300 includes a headset.

The electronic device 300 can create media content such as generate a virtual object or capture (or record) content through a camera. The electronic device 300 can encode the media content to generate a bitstream, such that the bitstream can be transmitted directly to another electronic device or indirectly such as through the network 102 of FIG. 1. The electronic device 300 can receive a bitstream directly from another electronic device or indirectly such as through the network 102 of FIG. 1.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

Various volumetric data encoding technologies are under development. For example, volumetric data represented in point cloud can be encoded as a Video-Based Point Cloud Compression (V-PCC) bitstream according to the ISO/IEC 23090-5 standard. At the same time, the same volumetric data can also be represented in a mesh and encoded as a Video-Based Dynamic Mesh Coding (V-DMC) bitstream according to ISO/IEC 23090-29. Point cloud can have an advantage in capturing and ideal for the applications requiring precise and detailed models whereas mesh is more suitable for animation and interactive application as it supports easy rendering and manipulation. Therefore, it may be required to provide two versions of same volumetric data to support wide range of application. In addition, for the clients with limited capability it may be also required to provide MIV version or 2D video version of volumetric data. The current ISO/IEC 23090-10 specification supports carriage of alternative structure of a volumetric data with same coding method. For example, a V-PCC bitstream can be carried by utilizing multiple atlas tile tracks as alternatives to a V-PCC bitstream only using single atlas track. However, there are no considerations of carrying volumetric data represented as point cloud and encoded as V-PCC bitstream as an alternative to such volumetric data represented as a mesh and encoded as a V-DMC bitstream. Furthermore, a 2D video version of volumetric data cannot be associated with volumetric data as alternatives.

This disclosure provides for supporting carriage of various versions of volumetric data as alternatives. In various embodiments, an alternate_group field of the TrackHeaderBox is used. In various embodiments of this disclosure, sample entry of the Visual Volumetric Video-Based Coding (V3C) atlas track, V3C bitstream tracks, and 2D video tracks are used to indicate the difference in representation and encoding of the volumetric data. A viewport information timed metadata track is used to provide information about the camera used to render 2D video of volumetric data.

Various standards have been proposed with respect to volumetric data coding. The following documents are hereby incorporated by reference in their entirety as if fully set forth herein:

ISO/IEC 23090-5 Video-based Point Cloud Compression;

ISO/IEC 23090-29 Video-based dynamic mesh coding (V-DMC);

ISO/IEC 23090-10 Carriage of Video-based Point Cloud Compression Data; and

ISO/IEC 23090-12 MPEG Immersive Video.

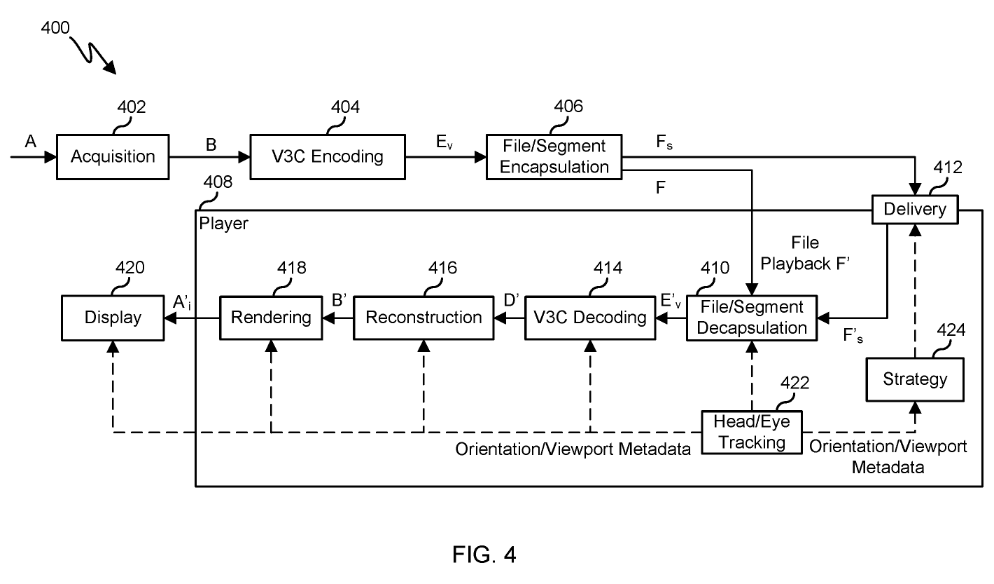

FIG. 4 illustrates an example volumetric media content flow process 400 in accordance with this disclosure. The process 400 illustrated in FIG. 4 is for illustration only. FIG. 4 does not limit the scope of this disclosure to any particular implementation of a volumetric media content flow process. For ease of explanation, the process 400 of FIG. 4 may be described as being performed using the electronic device 300 of FIG. 3. However, the process 400 may be used with any other suitable system and any other suitable electronic device, or a combination of electronic devices.

V3C provides a mechanism for coding visual volumetric frames. Visual volumetric frames are coded by converting the 3D volumetric data into a collection of 2D frames and associated data. The converted 2D frames are coded using video and image coding specifications and the associated data, e.g., atlas data and base mesh data, coded according to ISO/IEC 23090-5 and ISO/IEC 23090-29, respectively. The coded frames and associated data are multiplexed and form a V3C bitstream.

A V3C bitstream includes one or more Coded Video Sequences (CVSs). A CVS starts with a Volumetric Parameter Set (VPS), included in at least one V3C unit or provided through external means, and contains one or more V3C units carrying V3C sub-bitstreams, with each V3C sub-bitstream associated with a V3C component., e.g., atlas, occupancy, geometry, base mesh. attribute, etc.

As shown in FIG. 4, a real-world or synthetic visual scene (A) is captured at an acquisition operation 402, such as by a set of cameras, a camera device with multiple lenses and sensors, by virtual cameras, etc. The acquisition operation 402 results in source volumetric data (B). The source volumetric data (B) can be represented as a point cloud or mesh as needed. A V3C encoding operation 404 encodes one or multiple volumetric frames as a coded V3C bitstream. If source volumetric data is represented as point cloud, a coded V3C bitstream includes an atlas bitstream, at most one occupancy bitstream, a geometry bitstream, and zero or more attribute bitstreams (Eᵥ).

If source volumetric data is represented as a mesh, a coded V3C bitstream includes an atlas bitstream, a base-mesh bitstream, a displacement bitstream, and an attribute bitstream (Eᵥ). A file/segment encapsulation operation 406 then packages one or more coded bitstreams into a media file for local playback (F) by a player 408, e.g., a decoding device, that receives the encoded volumetric data at a file-segment decapsulation operation of the player 408, or the player 408 receives, at delivery operation 412, a sequence of an initialization segment and media segments for streaming (Fₛ), according to a particular media container file format.

In various embodiments of this disclosure, to support a wide range of applications, volumetric data (B) can be represented in both point cloud and mesh and both are encoded as two separate V3C bitstreams (Eᵥ) and packaged as alternatives to each other. In various embodiments, in addition to point cloud and mesh representation, a 2D video representation of volumetric data can also be created and encoded as a 2D video bitstream and then multiplexed together with a V3C bitstream as another alternative.

The file (F) that the file/segment encapsulation operation 406 outputs is identical to the file (F’) that a file/segment decapsulation operation 410 takes as input. The file/segment decapsulation operation 410 processes the file (F') or the received segments (F'ₛ) and extracts the coded bitstreams (E'ᵥ) and parses the metadata. The V3C bitstream is then decoded by a V3C decoding operation 414 into a decoded signal (D'). The decoded volumetric data (D') is reconstructed at a reconstruction operation 416 to provide reconstructed volumetric data (B’), rendered at a rendering operation 418 to provide a rendered real-world or synthetic visual scene (A’ᵢ), and displayed via a display operation 420, such as onto a screen of a head-mounted display or any other display device based on the current viewing orientation or viewport.

In various embodiments, the current viewing orientation can be determined by a head and/or eye tracking operation 422. In viewport-dependent delivery, the current viewing orientation can also be passed to a strategy operation 424, which determines the tracks to be received based on the viewing orientation.

Although FIG. 4 illustrates one example encoding volumetric media content flow process 400, various changes may be made to FIG. 4. For example, the number and placement of various components of the process 400 can vary as needed or desired. In addition, the volumetric media content flow process 400 may be used in any other suitable process and is not limited to the specific processes described above.

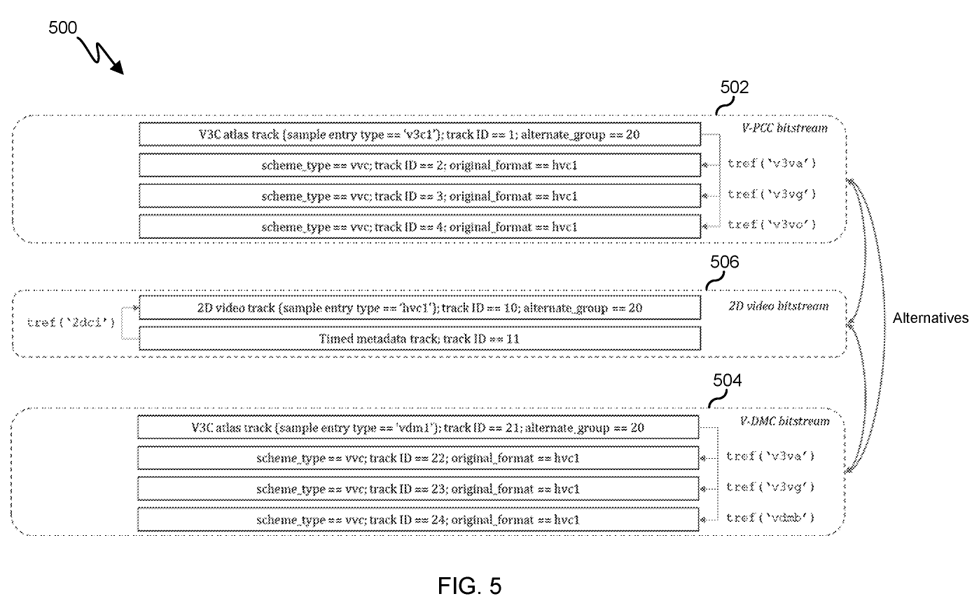

FIG. 5 illustrates example alternative volumetric data representations 500 in accordance with this disclosure. The alternative volumetric data representations 500 illustrated in FIG. 5 is for illustration only. FIG. 5 does not limit the scope of this disclosure to any particular implementation of alternative volumetric data representations. For ease of explanation, the alternative volumetric data representations 500 of FIG. 5 may be described as being used using the electronic device 300 of FIG. 3. However, the alternative volumetric data representations 500 may be used with any other suitable system and any other suitable electronic device.

As shown in FIG. 5, volumetric data may be represented and encoded in various versions in a file. In various embodiments, the different alternatives can be indicated by an alternate track mechanism, e.g., an alternate_group field of a TrackHeaderBox. V3C atlas tracks or V3C bitstream tracks which have the same alternate_group value can be differently represented and encoded versions of the same volumetric data. Video tracks which have the same alternate_group value with V3C atlas tracks or V3C bitstream tracks can be a 2D representation of the same volumetric data. For example, the alternative volumetric data representations 500 of FIG. 5 include a point cloud (V-PCC) bitstream alternative 502, a mesh bitstream (V-DMC) alternative 504, and a 2D video bitstream alternative 506, where each of the bitstream alternatives 502, 504, 506 share the same alternate_group value (a value of 20 in this example).

In various embodiments, the sample entry of the V3 atlas track, V3C bitstream tracks, and 2D video tracks can provide information to indicate the difference in representation and encoding of the volumetric data. When various versions of volumetric data are grouped together as alternatives to each other, for example, a track_in_movie flag can be set for one or more tracks with volumetric data, but, when the 2D video track is a provided alternative of volumetric data, the track_in_movie flag of the 2D video track can be set to 0. When 2D video is an alternative of V3C content, viewport information timed metadata track can optionally be present to provide information about the camera used to render 2D video. Such viewport information timed-metadata track can reference the corresponding 2D video track and “2dci” can be used for reference_type. When such a viewport timed-metadata track is provided, the value of viewport_type can be set to “0.”

As demonstrated by FIG. 5, to support various applications with different decoders and renderers volumetric data can be represented and encoded as different versions. For example, volumetric data represented as point cloud and encoded as V-PCC bitstream can also be represented as mesh and encoded as V-DMC bitstream at the same time and stored in a same file as an alternative to each other. In addition, the same volumetric data can be rendered as 2D video at certain viewpoints and encoded as a 2D video bitstream for the application with limited capabilities. An application, e.g., a player on a decoding device, can check the value of sample entry type of the tracks with the same alternate_group value to understand the types of volumetric data offered as alternatives and select the bitstream matching the application’s use cases or capabilities. In some embodiments, the application can receive a bitstream including two or more of the available alternatives, and select one of the alternatives to use during encoding. In some embodiments, the application can negotiate, such as with a server, to receive a transmission including one of the available alternatives.

As shown in the example of FIG. 5, there are two different 3D representations of volumetric data (the point cloud bitstream alternative 502 and the mesh bitstream alternative 504) and one 2D video representation of volumetric data (2D video bitstream alternative 506) provided as alternatives to each other. These alternatives have an identical value of the alternate_group field of the tracks whose IDs are 1, 10 and 21, respectively, which indicates that they are alternatives to each other. The different values of the sample entry type fields of the tracks sharing the same value of the alternative_group, namely ‘v3c1’, ‘vdm1’ and ‘hvc1', indicates that they are different representations and encodings of the same volumetric data.

In the example of FIG. 5, the sample entry type value ‘v3c1’ of the track whose ID is 1 indicates that tracks having an ID that is in a range between 1 and 4 comprise the point cloud (V-PCC) bitstream version of the volumetric data. The sample entry type value ‘vdm1’ of the track whose ID is 21 indicates that the tracks having an ID that is in a range between 21 and 24 comprise the mesh (V-DMC) bitstream version of the volumetric data. In addition, sample entry type value ‘hvc1’ of the track whose ID is 10 indicates that the track contains the 2D video bitstream version of the volumetric data. The track reference type value “2dci” indicates that the track whose ID is 21 is a timed metadata track that contains the information about the camera used to render 2D video in the track having an ID of 10.

Although FIG. 5 illustrates one example of alternative volumetric data representations 500, various changes may be made to FIG. 5. For example, one of the volumetric data types shown in FIG. 5 may not be included as an alternative, or other volumetric data types now known or developed in the future may be included.

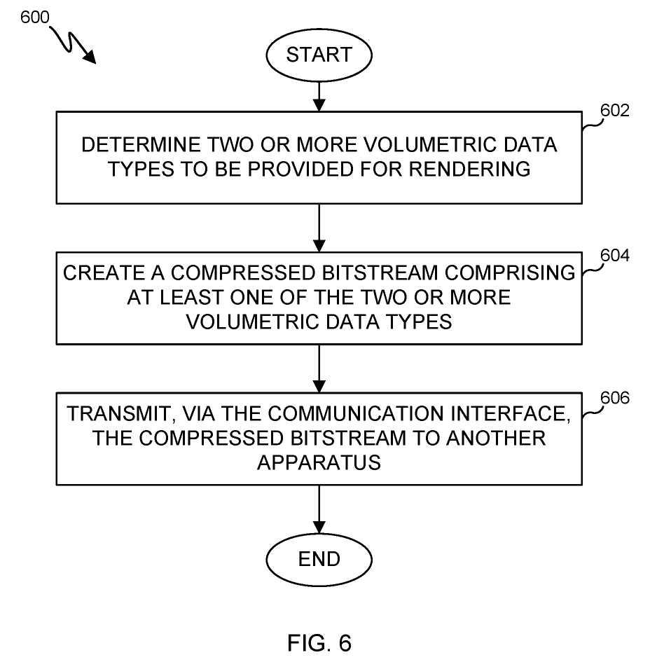

FIG. 6 illustrates an example encoding method 600 in accordance with this disclosure. For ease of explanation, the method 600 of FIG. 6 is described as being performed using the electronic device 300 of FIG. 3. However, the method 600 may be used with any other suitable system and any other suitable electronic device.

The method 600 can be performed as part of creating a compressed bitstream including an alternative bitstream for volumetric data. At step 602, two or more volumetric data types are determined to be provided for rendering. As described in various embodiments of this disclosure, the two or more volumetric data types can include a point cloud type, a mesh type, and/or a 2D representation type. As also described in various embodiments of this disclosure, the two or more volumetric data types can be associated by a volumetric data type alternate group. As also described in various embodiments of this disclosure, the volumetric data type alternate group can be indicated by a group identifier, each of the two or more volumetric data types in the volumetric data type alternate group can indicated by a type value, and one or more track identifiers can be associated with the type value.

At step 604, a compressed bitstream is created including at least one of the two or more volumetric data types. As described in various embodiments of this disclosure, the compressed bitstream can include volumetric data of each of the two or more volumetric data types. At step 606, the compressed bitstream is transmitted to another apparatus. The output compressed bitstream can be transmitted to an external device or to a storage on the electronic device 300. As described in various embodiments of this disclosure, the apparatus creating and/or storing the compressed bitstream may perform a negotiation with the other apparatus to transmit a determined type of volumetric data, and the transmitted compressed bitstream can include the determined type of volumetric data as a result of the negotiation.

Although FIG. 6 illustrates one example of an encoding method 600, various changes may be made to FIG. 6. For example, while shown as a series of steps, various steps in FIG. 6 may overlap, occur in parallel, or occur any number of times.

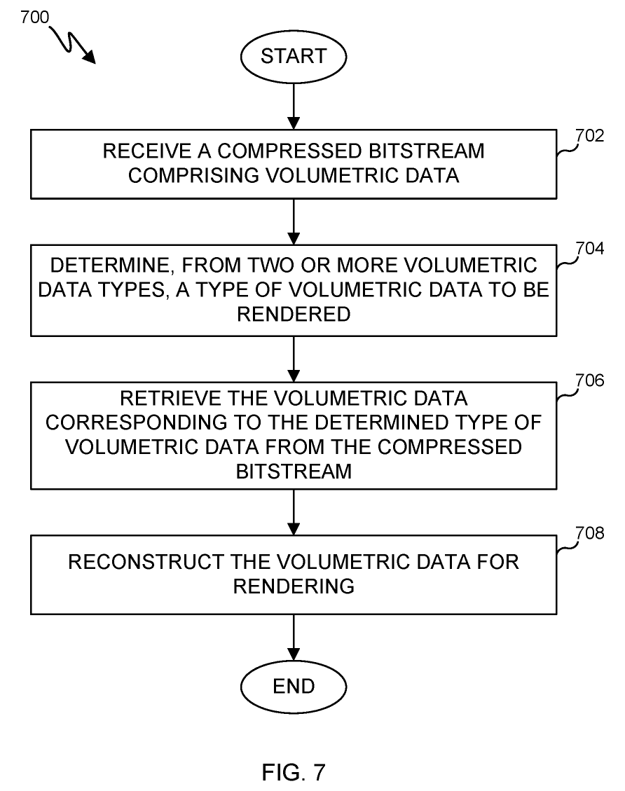

FIG. 7 illustrates an example decoding method 700 in accordance with this disclosure. For ease of explanation, the method 700 of FIG. 7 is described as being performed using the electronic device 300 of FIG. 3. However, the method 700 may be used with any other suitable system and any other suitable electronic device.

As shown in FIG. 7, at step 702, a compressed bitstream including volumetric data is received by the electronic device 300. At step 704, the electronic device 300 determines, from two or more volumetric data types, a type of volumetric data to be rendered. As described in various embodiments of this disclosure, the two or more volumetric data types can include a point cloud type, a mesh type, and/or a 2D representation type. As also described in various embodiments of this disclosure, the two or more volumetric data types can be associated by a volumetric data type alternate group.

At step 706, the electronic device 300 retrieves the volumetric data corresponding to the determined type of volumetric data from the compressed bitstream. As also described in various embodiments of this disclosure, the volumetric data type alternate group can be indicated by a group identifier, and each of the two or more volumetric data types in the volumetric data type alternate group is indicated by a type value. As also described in various embodiments of this disclosure, the volumetric data can be retrieved based on the type value and one or more track identifiers associated with the type value. As also described in various embodiments of this disclosure, the volumetric data of the compressed bitstream can include volumetric data of each of the two or more volumetric data types, and the volumetric data can be retrieved from the compressed bitstream by decoding the compressed bitstream and selecting the determined type of volumetric data for rendering from the decoded bitstream.

At step 708, the electronic device reconstructs the volumetric data for rendering. As also described in various embodiments of this disclosure, the electronic device 300 can perform a negotiation with another apparatus to receive the determined type of volumetric data, and the compressed bitstream received by a communication interface of the electronic device can include the determined type of volumetric data as a result of the negotiation. In various embodiments, the electronic device 300 can output the decoded content using the reconstructed volumetric data, such as 3D video. The output decoded content can be transmitted to an external device, such as a display device, or to a storage device on the electronic device 300 or on another device, for example.

Although FIG. 7 illustrates one example of a decoding method 700, various changes may be made to FIG. 7. For example, while shown as a series of steps, various steps in FIG. 7 may overlap, occur in parallel, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
a communication interface configured to receive a compressed bitstream comprising volumetric data; and
a processor operably coupled to the communication interface, wherein the processor is configured to:
determine, from two or more volumetric data types, a type of volumetric data to be rendered;
retrieve the volumetric data corresponding to the determined type of volumetric data from the compressed bitstream; and
reconstruct the volumetric data for rendering.

2. The apparatus of claim 1, wherein the two or more volumetric data types include a point cloud type, a mesh type, or a 2D representation type.

3. The apparatus of claim 1, wherein the two or more volumetric data types are associated by a volumetric data type alternate group.

4. The apparatus of claim 3, wherein the volumetric data type alternate group is indicated by a group identifier, and wherein each of the two or more volumetric data types in the volumetric data type alternate group is indicated by a type value.

5. The apparatus of claim 4, wherein the volumetric data is retrieved based on the type value and one or more track identifiers associated with the type value.

6. The apparatus of claim 1, wherein:
the volumetric data of the compressed bitstream includes volumetric data of each of the two or more volumetric data types; and
the volumetric data is retrieved from the compressed bitstream by decoding the compressed bitstream and selecting the determined type of volumetric data for rendering from the decoded bitstream.

7. The apparatus of claim 1, wherein the apparatus performs a negotiation with another apparatus to receive the determined type of volumetric data, and the compressed bitstream received by the communication interface includes the determined type of volumetric data as a result of the negotiation.

8. A method comprising:
receiving a compressed bitstream comprising volumetric data;
determining, from two or more volumetric data types, a type of volumetric data to be rendered;
retrieving the volumetric data corresponding to the determined type of volumetric data from the compressed bitstream; and
reconstructing the volumetric data for rendering.

9. The method of claim 8, wherein the two or more volumetric data types include a point cloud type, a mesh type, or a 2D representation type.

10. The method of claim 8, wherein the two or more volumetric data types are associated by a volumetric data type alternate group.

11. The method of claim 10, wherein the volumetric data type alternate group is indicated by a group identifier, and wherein each of the two or more volumetric data types in the volumetric data type alternate group is indicated by a type value.

12. The method of claim 11, wherein the volumetric data is retrieved based on the type value and one or more track identifiers associated with the type value.

13. The method of claim 8, wherein:
the volumetric data of the compressed bitstream includes volumetric data of each of the two or more volumetric data types; and
the volumetric data is retrieved from the compressed bitstream by decoding the compressed bitstream and selecting the determined type of volumetric data for rendering from the decoded bitstream.

14. The method of claim 8, further comprising performing a negotiation with an apparatus to receive the determined type of volumetric data, and the compressed bitstream includes the determined type of volumetric data as a result of the negotiation.

15. An apparatus comprising:
a communication interface; and
a processor operably coupled to the communication interface, the processor configured to:
determine two or more volumetric data types to be provided for rendering;
create a compressed bitstream comprising at least one of the two or more volumetric data types; and
transmit, via the communication interface, the compressed bitstream to another apparatus.

16. The apparatus of claim 15, wherein the two or more volumetric data types include a point cloud type, a mesh type, or a 2D representation type.

17. The apparatus of claim 15, wherein the processor is configured to associate the two or more volumetric data types by a volumetric data type alternate group.

18. The apparatus of claim 17, wherein:
the volumetric data type alternate group is indicated by a group identifier;
each of the two or more volumetric data types in the volumetric data type alternate group is indicated by a type value; and
one or more track identifiers are associated with the type value.

19. The apparatus of claim 15, wherein the compressed bitstream includes volumetric data of each of the two or more volumetric data types.

20. The apparatus of claim 15, wherein the apparatus performs a negotiation with the other apparatus to transmit a determined type of volumetric data, and the compressed bitstream transmitted by the communication interface includes the determined type of volumetric data as a result of the negotiation.
